(19) United States
(12) Patent Application Publication
(10) Pub. No.: US 2025/0104880 A1
(43) Pub. Date: Mar. 27, 2025

(54) CONTAINMENT ISOLATION TEST FIXTURE FOR LEAK RATE TESTING

(71) Applicant: NuScale Power, LLC, Corvallis, OR (US)

(72) Inventors: Brian Kanen, Seabrook, NH (US); Preston Vock, Pittsburgh, PA (US); Gary McGee, Corvallis, OR (US); Augi Cardillo, Pittsburgh, PA (US); Garret Ascherl, Richland, WA (US)

(73) Assignee: NuScale Power, LLC, Corvallis, OR (US)

(21) Appl. No.: 18/890,676

(22) Filed: Sep. 19, 2024

Related U.S. Application Data
(60) Provisional application No. 63/539,761, filed on Sep. 21, 2023.

(51) Int. Cl. G21C 17/00; G01M 3/32; G21C 13/073; G21C 13/10

(52) U.S. Cl. CPC G21C 17/002; G01M 3/3272; G21C 13/0735; G21C 13/10

(57) ABSTRACT

An apparatus including an integrated system, which can include a nuclear reactor; and a containment isolation system configured to prevent release of radioactive material from the nuclear reactor. The containment isolation system can include a containment vessel and a containment isolation test valve. The containment isolation test valve can include a body having a first test port and a first test port plug. The containment isolation test valve can include a cover configured to couple with the body, the cover having, a first seal, a second seal, an area between the first seal and the second seal, a second test port, and a second test port plug. The containment isolation system can include a containment isolation valve.

### STATEMENT REGARDING FEDERALLY SPONSORED RESEARCH

This invention was made with Government support under Contract No. DE-NE0008928 awarded by the Department of Energy. The Government has certain rights in this invention.

### CROSS-REFERENCE TO RELATED APPLICATIONS

This application claims the benefit of U.S. Provisional Patent Application No. 63/539,761 filed on Sep. 21, 2023 and titled “CONTAINMENT ISOLATION TEST FIXTURE (CTIF) FOR LEAK RATE TESTING,” which is incorporated herein by reference in its entirety.

### BACKGROUND

Nuclear reactors utilize containment isolation systems to isolate fluid systems in nuclear reactors. The containment isolation systems provide protection for external systems from contamination and/or radiation exposure. The containment isolation systems provide the means for isolating fluid systems that pass-through penetrations in the pressure vessel (e.g., containment isolation valve(s)). The fluid systems that pass through the penetrations in the pressure vessel may be used to transport potentially radioactive and/or contaminated fluid.

By using a containment isolation system, a nuclear reactor may, when a containment isolation valve (CIV) is shut, prevent, or reduce the likelihood of, leakage downstream of the CIV of any fluids and/or materials containing radioactivity. To analyze the condition of, capability of, and/or reliability of the CIV, the CIV may be periodically tested. Results of testing of the CIV may be utilized to verify that the CIV is likely to prevent, or reduce the likelihood of, fluids and/or materials from passing through a CIV should an accident occur. Typically, a CIV is tested by manipulating a valve within the pressure vessel (i.e., a high radiation area) and/or installing a temporary test fitting for use during the leak test. The temporary test fitting, not being installed on the CIV during normal operation, may be installed on the CIV during the test and then removed.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 schematically illustrates an integrated nuclear power plant system that includes a power plane system that uses a Small Nuclear Reactor (SMR) system with Nuclear Power Modules (NPMs) that contain Containment Isolation Test Fixtures (CITF) to be used during Containment Isolation Valve (CIV) leak testing.

FIG. 2 schematically illustrates an embodiment of an NPM integrated with a containment isolation system (CIS) having a CITF that is installed upstream of the CIV.

FIG. 3 illustrates a close-up and side-looking cross-sectional view of a portion of a CIS utilizing a CITF upstream of a CIV.

FIG. 4 illustrates a close-up and side-looking cross-sectional view of a CITF.

FIG. 5 illustrates a side-looking cross-sectional view of another embodiment of a CITF, with covers being moved toward a body of the CITF.

FIGS. 6A-6C illustrate example top-views of position indication for a CITF on a CITF cover.

FIG. 7 shows cross-sectional views of an embodiment of a CITF, with a spindle that is separate from the cover.

FIG. 8 shows a diagram of P&ID isolation barrier to allow for an in-situ leak rate pressure test between the CNV and CIV

FIG. 9 illustrates block diagram 900 with various conditions related to a process for performing testing operations.

FIG. 10 is a partially schematic, partially cross-sectional view of a nuclear reactor system configured in accordance with embodiments of the present technology.

FIG. 11 is a partial schematic, partial cross-sectional view of a nuclear reactor system configured in accordance with additional embodiments of the present technology.

FIG. 12 is a schematic view of a nuclear power plant system including multiple nuclear reactors in accordance with embodiments of the present technology.

### DETAILED DESCRIPTION

### Overview

This disclosure is directed to a small modular reactor (SMR) system utilizing at least one nuclear power module (NPM) having a containment isolation system (CIS) integrated with a containment isolation test fixture (CITF) (e.g., containment isolation test valve, isolation test valve, etc.) included between a containment vessel (e.g., a reactor pressure vessel) and a containment isolation valve (CIV). The CIV may be a single unit containing multiple valves (e.g., a first disc and seat fluidly connected to a second disc and seat within the same valve body). Alternatively, the CIV may be multiple separate valves fluidly connected to each other acting as a single valve unit (e.g., a first valve with a second valve directly downstream of the first valve). An integrated CITF (e.g., the CITF being integrated with the CIS) may allow for leak testing a CIV more quickly than a typical leak testing operation to minimize radiation exposure to workers. The integrated CITF may reduce, or eliminate, false negative isolation valve test results caused by the test fittings used in conventional systems.

The CITF may be assembled, installed, and operated to enable efficient and reliable testing of a CIV. A CITF may be positioned downstream to a containment vessel (e.g., an SMR pressure vessel) and upstream of a CIV. The CITF may include a disc, which may be operated to engage with seats within the CITF to isolate pressure downstream of the disc. The CITF may be manually adjusted with a tool before and after testing of the CIV to ensure that the CIS is a condition for testing and/or normal operations, as required. Nuclear reactor systems with CITFs may be utilized to test reliability and capability of CIVs prior to operating the nuclear reactor systems.

Typically, such as in a conventional nuclear reactor system, one of two CIV leak tests operations may be performed to verify operation of the CIVs. If the conventional nuclear reactor system includes an isolation valve within the containment vessel, the isolation valve may be utilized to perform an internal isolation test of the CIVs. If the conventional nuclear reactor system does not include an isolation valve within the +containment vessel, then a test plate isolation test of the CIVs may be performed.

Both of the typical test operations have distinct disadvantages. Regardless of the specific operation used for the conventional nuclear reactor system, CIV leak testing may utilize a portion of the CIS (i.e., upstream of the CIV) that is isolated and pressurized with the CIV closed. By closing the CIV and isolating and pressurizing the portion of the CIS with the CIV, leak testing of the CIV may be performed to verify operation of the CIV within testing parameters.

The isolated and pressurized portion of the CIS may be utilized in the conventional nuclear reactor system to test the CIV. If the isolated and pressurized portion of the CIS does not lose pressure, then the CIV passes the test since fluid was unable to pass downstream through the CIV while the CIV was shut. If the pressure drops below a specified threshold while the CIV is shut, then the CIV failed the test since fluid was able to pass through CIV despite it being shut.

The typical internal isolation test may utilize a valve (i.e., an inside valve) and a test fitting. The inside valve may be installed within the containment vessel. The test fitting may be installed outside the containment between the containment vessel and the CIV. This typical internal isolation test may be performed by accessing the inside of the containment vessel (e.g., such as to manipulate the inside valve. However, a radiation worker, while accessing the inside of the containment vessel, may spend time in the containment vessel (which increases the worker's radiation exposure). The radiation worker may spend extended periods of time within the containment vessel of the conventional nuclear reactor system to perform testing-related operations.

The testing-related operations performed by the radiation worker for the conventional nuclear reactor system may be lengthy and time consuming. The testing-related operations may include manipulating the inside valve before and after the testing. For example, the inside valve, being shut before the testing begins and opened after the testing is completed, may enable the CIV to be tested for leaks. The portion of the CIS between the closed inside valve and the CIV may be then pressurized through the test fitting to test the CIV.

This typical internal isolation test may provide false negative leak test results if the test fitting leaks. Typical testing operations for conventional nuclear reactor systems may be unable to be used to determine, within testing parameters, if the leak is from the temporary test fitting or a faulty CIV. The typical internal isolation test may also cause excessive radiation exposure to workers that open and close the inside valve in addition to installing and removing the test fitting.

The typical test plate isolation test may be utilized to test the temporary installation of a blank flange (e.g., a small plate) on the upstream side of the CIV (i.e., between the containment vessel and the CIV) in a conventional nuclear reactor system. Similar to the typical internal isolation test, the typical test plate isolation test may also produce false negative test results, such as for cases in which the blank flange is installed improperly. The typical test plate isolation test may also produce false negative test results, such as for cases in which the workers are unable to discern the true cause of the leak. Identifying the true cause of leaks may be complex and time consuming and may result in the workers spending lengthy periods of time in high radiation areas. False negative leak test results may result in unnecessary maintenance (e.g., the unnecessary replacement of CIV components), which may lead to excessive exposure and increased cost.

In addition to the expense of unnecessarily replacing components, false negative test results may cause longer downtime for the conventional nuclear reactor (i.e., the time required to replace CIV components and re-test). False negative test results, which may occur for typical test plate isolation tests, may result in increased radiation exposure for workers replacing the components in the conventional nuclear reactor during the relatively longer downtime. False negative test results, which may occur for typical test plate isolation tests during the relatively longer downtime, may result in workers spending more time in the high-radiation areas. The workers may spend relatively greater amounts of time in high radiation areas to be able to manipulate the inside valve multiple times for re-testing, performing the unnecessary maintenance (e.g., replacing satisfactory CIV components), etc. The typical test plate isolation test for the conventional reactors may result in production of relatively larger amounts of radioactive waste (i.e., tools, materials, rags, protective clothing, etc.).

In an embodiment, a CIS in a nuclear reactor system may include a containment vessel (e.g., a reactor pressure vessel, a reactor containment vessel, etc.), a CITF, and one or more CIVs. The CITF may include a body, a cover, and a CITF disc and seat assembly. The CITF seat and disc assembly may include a CITF disc (e.g., ball, butterfly, etc.), a CITF front seat (i.e., the seat proximate to the inlet side of the body), and a CITF backseat (i.e., the seat proximate to the outlet side of the body). It is understood that the number of seats may vary depending on the type of valve disc being used. For example, a butterfly valve disc may only have one seat, a globe valve disc may only have one seat, a gate valve may have a front seat and a backseat, etc. The CITF may be oriented with a specific upstream side (e.g., the side proximate to the containment vessel) and a downstream side (e.g., the side proximate to the CIV), with flow going through the CITF from the upstream side to the downstream side.

In an embodiment, the cover may be coupled to the body utilizing a dual seal to provide a leak-tight joint between the cover and the body. For example, the mating surface of the cover (i.e., the surface of the cover configured to planarly contact the cover) may include a first seal (e.g., the inner seal) and a second seal (e.g., the outer seal) separated by an area between the inner seal and the outer seal (e.g., the inner seal area). In an embodiment, the cover may include a seal test port that extends from the inner seal area to the outside of the cover (i.e., creating a flow path for fluid between the inner seal area and the outside of the cover), and the seal test port may include a seal test port plug (e.g., first port plug, first plug, etc.) configured to couple with the cover (i.e., the seal test port plug and the seal test port plug may be threaded).

In embodiments, the CIV may include two disc and seat assemblies (or “CIV disc and seat assemblies”). A first CIV front seat (e.g., the first CIV front seat) and a first CIV disc (e.g., the first CIV disc) may be configured to be upstream of a second CIV front seat (e.g., the second CIV front seat), a second CIV disc (e.g., the second disc), and a second CIV backseat. Fluid flowing through the CIV may be directed through the first CIV front seat and the first CIV disc (e.g., the first CIV disc and seat assembly). The fluid may then pass through the second CIV front seat, the second CIV disc, and the second CIV backseat (e.g., the second CIV disc and seat assembly). Following these embodiments, the inlet to the CIV may be the upstream portion of the first CIV disc and seat assembly. The outlet of the CIV may be the downstream portion of the second CIV disc and seat assembly. It is understood that CIV may include a first disc and seat assembly having a front seat and a backseat and/or the CIV may include a second disc and seat assembly that includes a single seat (e.g., a front seat or a backseat).

In embodiments, the first CIV disc and seat assembly and the second CIV disc and seat assembly may be any type of disc and seat assembly found in any type of ball valve, globe valve, gate valve, or other suitable isolation valve. Individual CIV disc and seat assemblies (e.g., the first CIV disc and seat assembly and the second CIV disc and seat assembly) passing the leak test may indicate that the CIV passes the leak test. Confirmation of the CIV disc and seat assemblies (e.g., the first CIV disc and seat assembly and the second CIV disc and seat assembly) passing the leak test may be utilized as confirmation that the CIV passes the leak test. Information indicating that either of the CIV disc and seat assemblies (e.g., the first CIV disc and seat assembly and the second CIV disc and seat assembly) fails the leak test may be utilized as an indication that the CIV fails the leak test.

In embodiments, and prior to performing a CIV leak test, the cover may be removed from the body of the CITF to allow access to the CITF internals (e.g., the CITF disc, the CITF seat, etc.). Once the cover is removed from the body, the CITF disc may be adjusted (i.e., using a tool configured to engage with a receptable in the CITF, to rotate the disc) to be in a closed position. By adjusting the CITF disc to the closed position, the CITF disc may be adjusted such that the CITF disc may engage with the CITF front seat and/or CITF backseat (depending on which side of the CITF disc is pressurized) to seal off a passageway between the inlet to the CITF and the outlet of the CITF. By sealing off the passageway between the inlet to the CITF and the outlet of the CITF, the CITF blocks fluid from flowing through the CITF. In an embodiment, the tool may be an allen wrench, a screwdriver (e.g., flathead, cross-tipped, torx tip, etc.), or any other suitable device configured to extend into the body of the CITF with the cover removed in order to adjust the CITF disc.

In embodiments, the CITF disc may be utilized to allow or to not allow fluid to pass through the body of the CITF. Additionally, or alternatively to the CITF including the receptable capable of receiving, and being adjusted by, the tool, the CITF disc may include a protrusion that extends toward the top of the body and may require the same or similar tool. For example, if pressure is applied to the downstream side of the CITF disc, the CITF disc may be forced into the CITF front seat. But, if pressure is applied instead to the upstream side of the CITF disc, the CITF disc may be forced into the CITF backseat. In an example embodiment, the CITF disc (e.g., the ball) may normally (e.g., during normal NPM operations) be positioned with the opening parallel to flow through the CITF disc, allowing fluid to pass, unrestricted, through the body (e.g., open). The CITF disc may be repositioned (e.g., rotated 90 degrees) such that the opening in the CITF disc may be block fluid from flowing through the body of the CITF. When the CITF disc opening is positioned to block flow through the body, the fluid is no longer allowed to pass through the body. By and instead builds pressure against the CITF disc (e.g., closed). The increased pressure against the CITF disc forces the CITF disc into one of the CITF seats with increased pressure, thereby sealing the CITF more securely. When CIV leak testing is completed, the cover may again be removed, and the CITF disc may be rotated to position the opening of the CITF disc such that the opening is parallel to the flow through the body.

In an embodiment, the CITF may be permanently installed to a nuclear power module (i.e., the upstream side of the body (e.g., inlet side) may be attached to the outside of and adjacent to the containment vessel (e.g., reactor pressure vessel) and the downstream side of the body (e.g., the outlet side) may be attached adjacent to the CIV). Since the NPM operates with the CITF installed, the CITF may be demonstrated to be leak-tight and therefore, should a leak test return negative results (e.g., no leak detected), the CITF connection joints (e.g., the welds connecting the body to the CIS) may be eliminated as potential sources of the leak. However, in these embodiments, because the cover of the CITF may be easily removed to provide access to the CITF disc and CITF seats, a replacement CITF disc (e.g., a previously tested CITF disc verified to not leak) may be quickly installed to perform a re-test. If the re-test returns a negative result, then the CIV may be confirmed as the source of the leak.

In an embodiment, performing a CIV leak test on an SMR system integrated with a CITF may include pressure testing each CIV disc and seat assembly within the CIV. In order for a CIV disc and seat assembly to pass a leak test, the CIV disc and seat assembly may be utilized to maintain a threshold pressure (e.g., test pressure) for a threshold amount of time (e.g., test duration). By ensuring that the pressure applied as a result of the CIV disc and seat assembly being adjusted is above the threshold pressure for the threshold amount of time, the CIV leak test may be performed at relatively greater level of accuracy and effectiveness.

To test the first CIV disc and seat assembly, the first CIV disc and disc assembly may be shut and the portion of the CIS between the CITF and the first CIV disc and seat assembly (e.g., the first testing portion) may be pressurized and held at a threshold pressure (e.g., a test pressure) for a threshold amount of time (e.g., testing duration). The results may be analyzed to verify operation of the CITF. To test the second CIV disc and seat assembly, the first CIV disc and seat assembly may be opened, the second CIV disc and seat assembly may be shut, and the portion of the CIS between the CITF and the second CIV disc and seat assembly (e.g., the second testing portion) may be pressurized held at a threshold pressure (e.g., a test pressure) for a threshold amount of time (e.g., testing duration), and the results may be analyzed.

A CIV leak test may begin by removing a CITF cover to expose the CITF disc (e.g., a ball) and the CITF seats (e.g., the CITF front seat and the CITF backseat). In an embodiment, the cover may include a spindle portion integral to the cover that extends into the body and fits inside an upper portion of the disc. In embodiments, the spindle portion may be separate from the CITF cover and have a first end configured to engage with the CITF cover and a second end configured to engage with the CITF disc. In embodiments, the spindle portion may be integrated with the CITF disc. The spindle portion of the CITF cover and the upper portion of the CITF disc may be configured such that when the spindle portion is in the upper portion of the CITF disc, the CITF disc may not rotate within the body (e.g., the end of the spindle portion and to top of the CITF disc may have complementary keyed surfaces, etc.).

In an embodiment, because the spindle portion of the cover may only be inserted into the CITF disc in a particular way (i.e., the complementary keyed surfaces may be aligned), when the CITF disc is rotated, the cover may also be replaced with a different orientation than when the cover was removed. For example, if the CITF disc is rotated 90 degrees in the clockwise direction, the cover may also require a 90-degree rotation in the clockwise direction in order for the keyed surfaces to align such that the spindle may be inserted into the body.

In an embodiment, the cover may include a marking on the outside surface to indicate which way the CITF disc opening is oriented. For example, if the CITF disc is in the open position with the cover installed, the outside surface may have an arrow depicted on the outside of the cover (e.g., an engraving, a raised portion, etc.) that is parallel with the fluid flow path through the body, and when the CITF disc is rotated 90 degrees to a closed position with the cover installed, the arrow depicted on the outside of the cover may be perpendicular to the fluid flow path through the body. Alternatively, or additionally, the indication on the outside of the cover may include lines or other reasonable visual position indication, including components required for remote position indication.

Because the CITF is permanently installed in the SMR system during normal NPM operations, the normal operating position for the CITF may include the CITF being in the open position (i.e., the CITF is shut during a CIV leak test). It is understood that although the CITF may also be shut to isolate fluid flow through the CIS for operations other than CIV leak testing (e.g., maintenance downstream of the CITF, downstream valve replacement, miscellaneous testing, etc.) After the CITF cover is removed, the CITF disc may be positioned to the closed position (i.e., a tool may be used to rotate the CITF disc to a position to block fluid flow through the body), and the CITF cover may be re-installed.

Once the cover is re-installed, the seal test port plug may be removed and a pressure detecting device (e.g., pressure sensor, pressure gauge, etc.) may be installed in the seal test port. When the pressure detecting device is installed in the seal test port, the pressure detecting device may detect the pressure within the inner seal area (i.e., the area between the first seal and the second seal within the cover). In an embodiment, a pressure sensing device (e.g., a pressure sensor) may be installed in the seal test port during normal operations.

In an embodiment, when the CTIF is shut and the CIS is pressurized (i.e., fluid is applying pressure against the CITF disc into either the CITF front seat or the CITF backseat), the fluid applying pressure against the CITF disc may also be felt against the inner seal of the cover. If the inner seal fails (i.e., fluid penetrates and/or passes through the inner seal), then fluid applying pressure to the CIS may be allowed to pressurize the inner seal area. The pressure detecting device connected to the inner seal area may detect the increased pressure of the inner seal area. In an embodiment, the pressure detecting device detecting an increase in pressure of the inner seal area may indicate a failed inner seal, which may be replaced.

After the pressure detecting device (e.g., pressure sensor, pressure gauge, etc.) is installed in the seal test port, the first CIV disc and seat assembly within the CIV may be shut (e.g., manually, via a remote valve operator, etc.) and the leak test port plug may be removed from the leak test port. In an embodiment, the leak test port (e.g., second port, second test port, etc.) may be located on the downstream side of the CITF. The leak test port may extend from the outside of the body to the downstream portion of the body (i.e., creating a flow path for fluid between the first and/or second testing portion and the outside of the CITF), and the leak test port may include a leak test port plug (e.g., the second port plug, the second plug, etc.) configured to couple with the body (i.e., the leak test port plug and the leak test port plug may be threaded). With the leak test port plug removed, a leak testing device may be attached to the body via the leak test port. The testing device may include a fluid pump, an isolation valve configured to block fluid flow, and a fitting to attach the fluid pump to the leak test port.

The leak testing device may pressurize the downstream portion of the CITF (e.g., the first testing portion) by pumping a fluid (e.g., an inert gas) through the leak test port. Because the fluid pressurizes the downstream portion of the CITF, the fluid may force the disc within the CITF against the CITF front seat (i.e., the CITF disc may be forced into the CITF seat toward the inlet side of the CITF). In the example embodiment, because the CITF disc is oriented in the closed position, the fluid may force the CITF disc against the CITF front seat of the body, and the inert gas may not pass through the body of the CITF. In the example embodiment, the downstream portion of the CITF is coupled with the inlet to the CIV. Because the portion of the CIS downstream of the CITF is being pressurized by the leak testing device, the inlet portion of the CIV is also being pressurized.

As the pressure downstream of the CITF increases, so also does the pressure on the inlet side of the first CIV disc and seat assembly increase, which forces the first CIV disc into the first CIV backseat of the first CIV disc and seat assembly. When the test pressure threshold (e.g., test pressure) is reached, the test pressure may be held steady for the appropriate period of time (e.g., the test duration), and the results may be analyzed. Once the results are analyzed, the first testing portion may be de-pressurized. The first CIV disc may then be opened (e.g., manually, via a remote valve operator, etc.) and the second CIV disc may be shut (e.g., manually, via a remote valve operator, etc.). In embodiments, only the CIV disc and seat assembly being tested may be shut while the CIV disc and seat assembly not being tested may be open (e.g., if the first CIV disc and seat assembly is shut for testing, the second CIV disc and seat assembly is open).

The leak testing device may pressurize the downstream portion of the CITF (e.g., the second testing portion) by pumping a fluid (e.g., an inert gas) through the leak test port. Because the fluid pressurizes the downstream portion of the CITF, the fluid may force the CITF disc within the CITF against the CITF front seat (i.e., the CITF disc may be forced into the CITF seat toward the inlet side of the CITF). In the example embodiment, because the CITF disc is oriented in the closed position, the fluid may force the CITF disc against the CITF front seat of the body, and the inert gas may not pass through the body of the CITF. As the pressure downstream of the CITF increases, so also does the pressure on the inlet side of the second CIV disc and seat assembly increase, which forces the second CIV disc into the second CIV backseat of the second CIV disc and seat assembly. When the test pressure threshold (e.g., test pressure) is reached, the test pressure is held steady for the appropriate period of time (e.g., the test duration), and the results may be analyzed. Once the results are analyzed, the second testing portion may be de-pressurized.

In an embodiment, if the CIV test is determined to pass because no leakage was detected (i.e., the test pressure was maintained for the entirety of the test duration), the CIV test process may be reversed to restore the CIS to the pre-CIV leak test condition. In an embodiment, if the CIV test is determined to fail because leakage was detected (i.e., the test pressure was not maintained for the entirety of the test duration), the CITF may be tested to determine whether the CITF (e.g., the CITF disc, the CITF front seat, the CITF backseat, the inner seal of the cover) is the source of failure. For example, in an embodiment, a CIV test may be performed, and the CIV being tested may fail because the portion of the CIS does not maintain pressure. In embodiments where the CIV test fails, the CITF may be tested to determine whether the source of the leak during the test was the CIV or the CITF. In an embodiment, if the pressure detecting device coupled to the cover of the CITF detects an increase in pressure of the inner seal area, then the inner seal of the CITF may be identified as the faulty component and the inner seal may be replaced and a new CIV leak test may begin. In embodiments where the CITF, or any components therein, are determined to be the source of a leak, the CITF may be more easily repaired than the CIV.

In an embodiment, if the pressure detecting device coupled to the cover did not detect a pressure increase, then the CITF disc may be replaced with a new disc (e.g., a disc previously tested and verified to not leak). In an embodiment, if the CITF disc is replaced with a new disc and the pressure detecting device does not detect increased pressure within the inner seal area, then the particular CIV disc and seat assembly being tested (e.g., the first CIV disc and seat assembly or the second CIV disc and seat assembly) may be determined to be the source of the leak.

### Illustrative Embodiments of a Containment Isolation Test Fixture

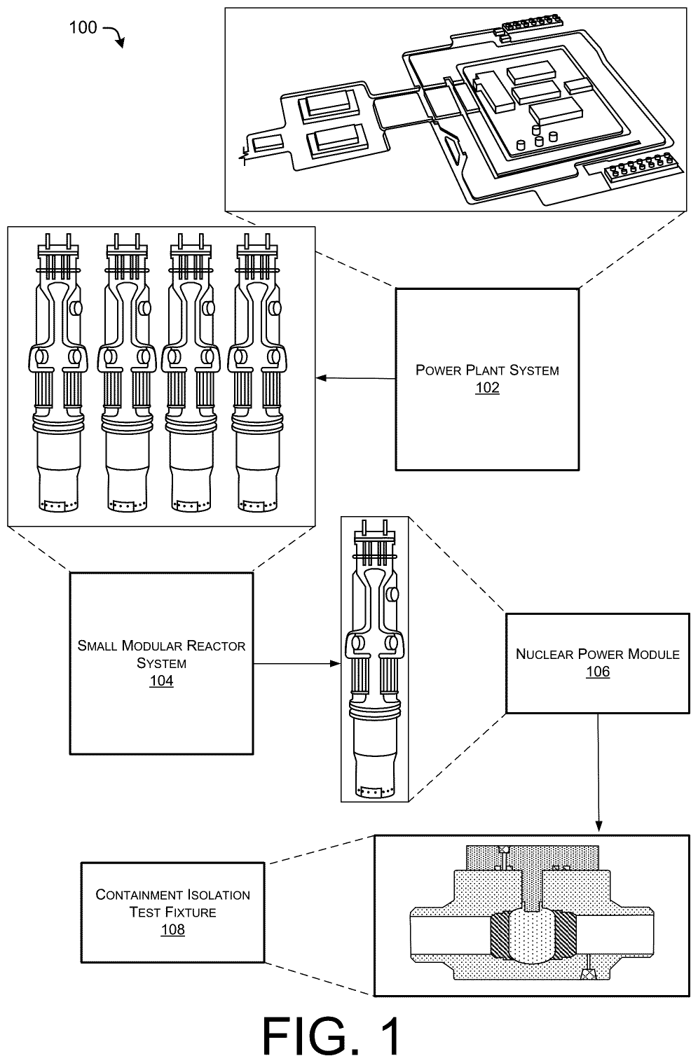

FIG. 1 schematically illustrates an integrated nuclear power plant system 100 that includes a power plant system 102 that uses a Small Nuclear Reactor (SMR) system 104 with Nuclear Power Modules (NPMs) 106 that have Containment Isolation Test Fixtures (CITF) 108 (e.g., isolation test valve) to be used during Containment Isolation Valve (CIV) leak testing.

In the illustrated embodiment, the SMR system 104 may include a multi-module power plant design with similar NPMs. However, in various instances, the SMR system 104 may represent any type of power plant system, including any of various other types of nuclear reactors and/or nuclear reactor systems. For example, the power plant system 102 may include multiple small modular reactors with the same or different sizes, or operating characteristics.

Within the SMR system 104, the CITF 108 may be integrated within the containment isolation system (CIS) of the NPM 106. The CIS of the NPM 106 may be configured to prevent and/or limit the release of radioactivity outside the containment vessel (e.g., the reactor pressure vessel) as necessary (i.e., nuclear accident, environmental casualty, maintenance, etc.). Because the CIS may be relied upon during emergent circumstances, the CIS may be periodically tested to ensure that the CIV does not allow fluid to flow through the CIS when the CIS is configured to block fluid flow through the CIS (e.g., when containment is set, when the CIS is secured, etc.) In an embodiment, the CIS of the NPM 106 may include a CITF 108 and a CIV. It is understood that the CIV may include multiple isolation valves within one housing (i.e., a first disc and seat assembly 330 and a second disc and seat assembly 332 within one housing) and/or multiple individual adjacent valves acting as a single CIV. In an embodiment, the NPM 106 may include a containment vessel that may have one or more CIVs within a CIS.

In an embodiment, the CITF 108 may be used to isolate a portion of the CIS for CIV leak testing. In an example embodiment, the CITF 108 and the CIV may be shut and the portion of the CITF 108 and the CIV (e.g., a first disc and seat assembly in a housing or a first isolation valve) may be pressurized to determine whether fluid is able to flow through the CIV. In the example embodiment, the CITF 108 may remain shut while additional valves are leak tested (e.g., additional CIVs, isolation valves, or any other valve fluidly connected downstream of the CITF 108).

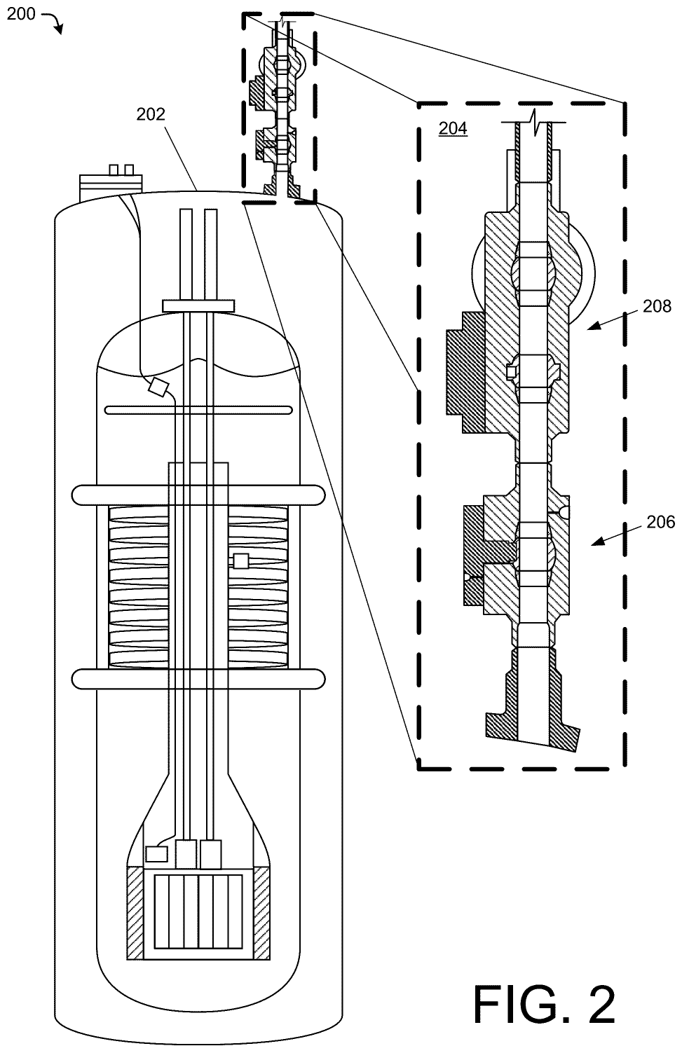

FIG. 2 schematically illustrates an embodiment of an NPM 200 integrated with a containment isolation system (CIS) 204 having a CITF 206 that is installed upstream of the CIV 208. The CITF 206 may be used to conduct CIV leak testing more quickly, more reliably, and with less radiation exposure for workers. CIS 204 may include a containment vessel 202, a CITF 206 and a CIV 208. It is understood that the CIV may include a single valve body that houses multiple valves (i.e., a first disc and seat assembly 330 and a second disc and seat assembly 332 within the CIV 208, etc.). It is also understood that CIS 204 may include multiple containment vessels, CITFs, and/or CIVs.

The NPM 200 may be the same or similar to the NPM 106 as discussed above with reference to FIG. 1. In an embodiment, the CIS may be used to prevent the release of radioactive material outside the containment vessel (e.g., the reactor pressure vessel) as necessary (i.e., nuclear accident, environmental casualty, maintenance, etc.) (e.g., to reduce the release of radioactive material outside the containment vessel to below predetermined and/or threshold levels. To ensure the dependability of the CIV's ability to reduce the release of radioactive material to below predetermined and/or threshold levels, the CIV may be leak tested to verify that, when the CIV is shut, the CIV does not allow, within testing tolerances and/or protocols, fluid to leak past the CIV. In embodiments where the CIV includes multiple disc and seat assemblies within a single housing (as depicted in FIG. 2), each disc and seat assembly may be separately leak tested. Similarly, in embodiments where the CIV includes multiple individual valves fluidly connected in series (i.e., directly adjacent to each other), each individual valve may be leak tested.

In an embodiment, the CIV may be leak tested by isolating a first portion of the CIS (e.g., a first test portion) to allow for pressure to be directed against the first disc and seat assembly. For example, a first test portion may include the CITF 206 and the first disc and seat assembly 330. Once the first test portion is isolated, the first test portion may be pressurized with a test fluid (i.e., inert gas, etc.) until the first test portion reaches a particular pressure (e.g., a first test pressure, etc.). After the first test portion is at a first test pressure, the first test portion may be observed for a specific duration of time (e.g., a first test duration) to ensure that the first disc and seat assembly may prevent leakage during sustained pressurization. In an embodiment, the first test portion may then be depressurized, and the CIS may be configured to isolate a second portion of the CIS (e.g., a second test portion) to allow for pressure to be directed against a second disc and seat assembly. For example, the second test portion may include the CITF 206 and the second disc and seat assembly 332. The second test portion may be pressurized, observed, and the results analyzed.

In an embodiment, when one or more of the disc and seat assemblies (e.g., all the disc and seat assemblies) within the CIV has been leak tested, the CIV leak test may be completed. If every disc and seat assembly within the CIV has been leak tested and determined to not leak, then the CIV may be classified as passing the CIV leak test. If any of the disc and seat assemblies within the CIV were determined to allow flow through the disc and seat assembly despite its being shut, then the CIV may be classified as failing the CIV leak test.

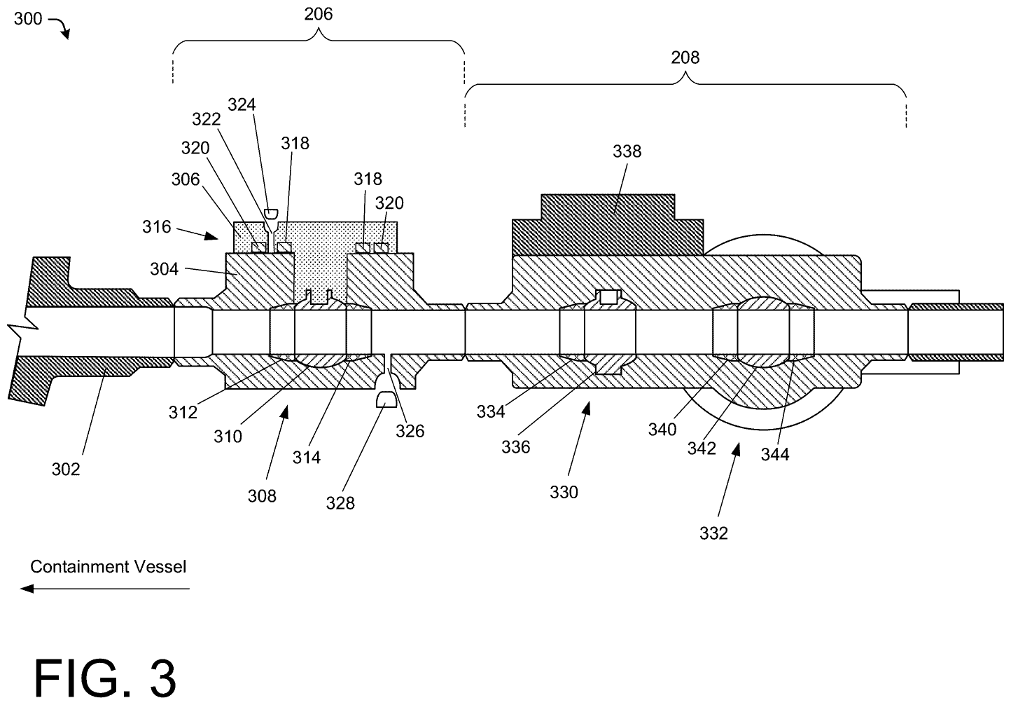

FIG. 3 illustrates a close up and side-looking cross-sectional view of a portion of a CIS 300 (“CIS 300”) utilizing a CITF 206 (e.g., an isolation test valve) upstream of a CIV 208. In an embodiment, CIS 300 may include a portion of a containment vessel 302 shown, simply for purposes of illustration, with diagonal lines, as represented in FIG. 3, the portion being integral with, and unseparated from, any remaining portion of the containment vessel 302. In some examples, the portion of the containment vessel 302 may be utilized to implement a corresponding portion of the containment vessel 202, as discussed above with reference to FIG. 2.

The portion of the containment vessel (also simply referred to herein as “containment vessel”) 302 (e.g., a reactor pressure vessel) may be included in the CIS 300 along with a CITF 206 and a CIV 208. The CITF 206 may include a body 304, a cover 306, and a disc and seat assembly 308. The seat and disc assembly 308 may include a disc 310 (e.g., ball, butterfly, etc.), a front seat 312 (i.e., the seat proximate to the inlet side of the body), and a backseat 314 (i.e., the seat proximate to the outlet side of the body). The disc 310 may be configured to receive an operating tool (e.g., allen wrench, cross-tipped screwdriver, flathead screwdriver, torx-tipped screwdriver, key, etc.) and be rotated in an open and closed position. For example, once the cover 306 is removed, an operating tool may be inserted within the body to engage with the disc 310, and rotate the disc 310 to the desired position.

It is understood that although depicted in FIG. 3, as having a front seat and a backseat, the CITF 206 may contain only a single seat. It is also understood that only a single seat may be necessary for CIV testing. It is understood that the number of seats may vary depending on the type of valve disc being used and/or the desired application. For example, a butterfly valve disc may only have one seat, a globe valve disc may only have one seat, a gate valve may have a front seat and a backseat, etc. The CITF 206 may be oriented with a specific upstream side (e.g., the side proximate to the containment vessel) and a downstream side (e.g., the side proximate to the CIV 208), with flow going through the CITF 206 from the upstream side to the downstream side.

In an embodiment, the cover 306 may be coupled to the body 304 utilizing a dual seal 316 to provide a leak-tight joint between the cover 306 and the body 304. For example, the mating surface of the cover 306 (i.e., the surface of the cover 306 configured to planarly contact the body 304) may include a first seal 318 (e.g., the inner seal) and a second seal 320 (e.g., the outer seal) separated by an area between the inner seal 318 and the outer seal 320 (e.g., the inner seal area). The first seal 318 may include a first side adjacent to the center of the body 304 and a second side, opposite the first side, that is adjacent to the second seal 320. The second seal 320 may include a first side adjacent to the first seal 318 and a second side, opposite the first side that is less proximate to the center of the body 304 than the first side of the second seal 320.

In an embodiment, the cover 306 may include a seal test port 322 (“port 322”) (e.g., first test port, first port, etc.) having a first side and a second side opposite the first side, wherein the first side is more proximate to the center of the body 304 than the second side. Port 322 may extend from the inner seal area to the outside of the cover 306 (i.e., creating a flow path for fluid between the inner seal area and the outside of the cover 306), and the test port 322 may include a seal test port plug 324 (“plug 324”) (e.g., first port plug, first plug, etc.) configured to couple with the cover 306 (i.e., plug 324 and port 322 may be threaded). The seal test port 322 may be disposed through the cover 306 such that the seal test port 322 extends between the first side of the first seal 318 and the first side of the second seal 320. For example, the first side of port 322 may be disposed adjacent to the first side of the first seal 318 and the second side of port 322 may be disposed adjacent to the first side of the second seal 320.

In an embodiment the body 304 may include a port 326 (e.g., second test port, second port, etc.) and a plug 328. In embodiments, port 326 (e.g., second port, second test port, etc.) may be located on the downstream side of the disc 310. The port 326 may extend from the outside of the body 304 to the downstream portion of the body 304 (i.e., creating a flow path for fluid between the first and/or second test portion and the outside of the body 304). Plug 328 (e.g., the second port plug, the second plug, etc.) may be configured to couple with the body 304 to seal port 326 (i.e., plug 328 and port 326 may be threaded). With the plug 328 removed, a leak testing device (not shown) may be attached to body 304 via the port 326. The testing device may include a fluid pump, an isolation valve configured to prevent backflow through the pump, and a fitting to attach the fluid pump to port 326. It is understood that port 322 may be on a first side of the disc and seat assembly 308 (e.g., an upstream side) and port 326 may be on a second side of the disc and seat assembly 308 (e.g., a downstream side).

In embodiments, the CIV 208 may include disc and seat assembly 330 (e.g., the first disc assembly, or “first valve”). The CIV 208 may include disc and seat assembly 332 (e.g., the second disc and seat assembly, or “second valve”).

Disc and seat assembly 330 may include front seat 334 (e.g., the first front seat) and a disc 336 (e.g., the first disc). In embodiments, the CIV 208 may include a cover 338. The cover 338 may be configured to couple with the CIV 208. In embodiments, the cover 338 may be removed to provide access to the internal parts (e.g., front seat 334, disc 336, etc.) of the disc and seat assembly 330. In embodiments, cover 338 may include one or more marks or other identifying indicia on a top surface of cover 338 that my serve as visual indications of the condition of the disc and seat assembly 330 (e.g., direction of flow, open position, closed position, etc.). For example, the cover 338 may include an arrow demonstrating the direction fluid would flow through the disc and seat assembly 330.

In an embodiment, the disc and seat assembly 330 may include a single seat ball valve to allow for thermal over pressure protection. In an assembly, the disc and seat assembly 330 may include an upstream seat to meet ANSI/ANS 56.2 requirements. Disc and seat assembly 332 may include front seat 340 (e.g., the second front seat), disc 342 (e.g., the second disc), and backseat 344. In an embodiment, disc and seat assembly 332 may include a dual seal ball valve for bidirectional scalability. Fluid flow through the CIV 208 may be directed through the front seat 334 and the disc 336 (e.g., the disc and seat assembly 330) before passing through front seat 340, disc 342, and backseat 344 (e.g., the disc and seat assembly 332) and a pipe end downstream of CIV 208.

Following these embodiments, the inlet to CIV 208 may be the upstream portion of the disc and seat assembly 330 and the outlet of CIV 208 may be the downstream portion of disc and seat assembly 332. In embodiments, the disc and seat assembly 330 and disc and seat assembly 332 may be similar to a typical disc and seat assembly found in a typical ball valve, globe valve, gate valve, or other suitable isolation valve. In some cases, the CIV 208 may pass a CIV leak test if both CIV disc and seat assemblies (330 and 332) each passes its individual leak test. In some cases, the CIV 208 may pass a CIV leak test if both CIV front seats (334 and 340) each passes its individual leak test. For example, verifying the CIV 208 as passing the CIV leak test may be based on all CIV disc and seat assemblies (e.g., both of the CIV disc and seat assemblies (330 and 332)) passing the CIV leak test. In such an example or another example, the CIV 208 failing the CIV leak test may be determined based on any CIV disc and seat assemblies (e.g., either or both of the CIV disc and seat assemblies (330 and 332)) failing the CIV leak test.

Prior to performing a CIV leak test, the cover 306 may be removed from the body 304 of the CITF 206 to allow access to the CITF internals (e.g., disc 310, front seat 312, backseat 314, etc.). Once the cover 306 is removed from the body 304, disc 310 may be adjusted (i.e., using a tool configured to engage with and rotate the disc) to position disc 310 such that disc 310 may engage with the front seat 312 and/or backseat 314 (depending on which side of disc 310 is pressurized) to restrict flow through CITF 206. In an embodiment, the tool may be an allen wrench, a screwdriver (e.g., flathead, cross-tipped, torx tip, etc.), or any other suitable device configured to extend into the body 304 of CITF 206 with the cover 306 removed in order to adjust disc 310. Additionally, or alternatively, the disc 310 may include a protrusion that extends toward the top of body 304 and may require the same or similar tool in order to position the disc 310.

In an embodiment, plug 328 may be removed from body 304, a leak testing device may be attached to the body 304, and the leak testing device may pump a testing fluid (e.g., an inert gas) into the body 304 via port 326 increase pressure in the isolated portion of the CIV. For example, if pressure is applied to the downstream side of disc 310, the disc 310 may be forced into front seat 312, but if pressure is applied instead to the upstream side of the disc 310, the disc 310 may be forced into backseat 314. In the example embodiment, the disc 310 (e.g., the ball) may normally (e.g., during normal NPM operations) be positioned with the opening parallel to flow through disc 310, allowing fluid to pass, unrestricted, through the body 304 (e.g., open). The disc 310 may be repositioned (e.g., rotated 90 degrees) such that the opening in disc 310 may restrict fluid flow through the body 304. When the opening in disc 310 is positioned to control (e.g., restrict, block, limit, etc.) flow through the body 304, the fluid may be controlled to no longer pass through the body 304. The fluid may instead build pressure against disc 310 (e.g., closed). The increased pressure against disc 310 may disc 310 into one of the CITF seats (e.g., front seat 312 or backseat 314) with increased pressure, thereby sealing CITF 206 more securely. When CIV leak testing is completed, the cover 306 may again be removed, and disc 310 may be rotated to position the opening of disc 310 such that the opening is parallel to the flow through the body.

Although the CIS 300 includes a single valve (e.g., the CITF 206) to test assemblies 330 and/or 332, as discussed above in the current disclosure, it is not limited as such. In some examples, the CIS 300 includes more than one fixture (e.g., more than one valve) similar to, or different from, the CITF 206, and/or operated similarly as, or differently from, the CITF 206. For example, any of the more than one fixture can include a fixture with a single seat, a fixture with two seats, any other type of fixture, or any combination thereof.

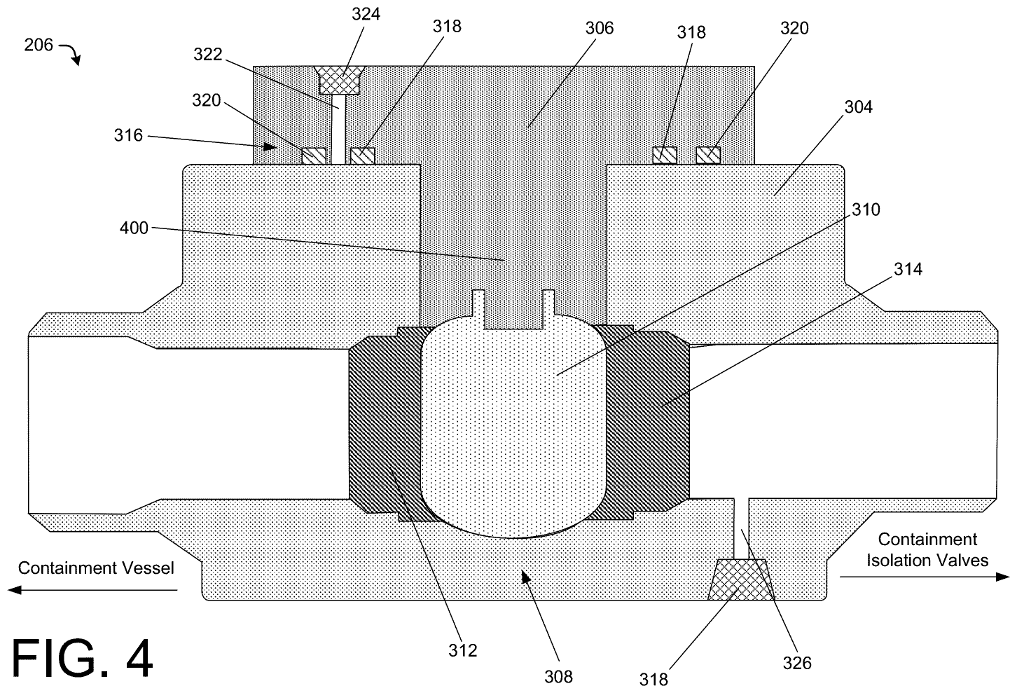

FIG. 4 illustrates a close-up and side-looking cross-sectional view of the CITF 206 of FIGS. 2 and 3. The close-up and cross-sectional view of the CITF 206 demonstrates a more detailed and close-up view of the orientation and operation of the CITF 206, the cover 306, the disc and seat assembly 308, the disc 310, the front seat 312, the backseat 314, the dual seal 316, the first seal 318, the second seal 320, the port 322, the plug 324, the port 246, and the plug 328.

In an embodiment, as demonstrated in FIG. 4, the cover 306 may include a spindle portion 400 that is integral to the cover 306. For instance, the spindle portion 400 can include a spindle. The spindle portion 400 may extend into the body 304 and fit inside an upper portion of the disc 310. The spindle portion 400 of the cover 306 and the upper portion of the disc 310 may be configured such that when the spindle portion is in the upper portion of the disc 310, the disc 310 may not rotate within the body 304 (e.g., the end of the spindle portion 400 and to top of the disc 310 may have complementary keyed surfaces, etc.). It is understood that in some embodiments, the spindle portion may be separate from the cover 306. It is also understood that in some embodiments, the spindle portion may be integrated with the disc 310 (i.e., the disc 310 may include a spindle portion that extends upward toward the cover 306).

In an embodiment, because the spindle portion 400 of the cover 306 may only be inserted into the disc 310 in a particular way (i.e., the complementary keyed surfaces may be aligned), when the disc 310 is rotated, the cover 306 may also be replaced with a different orientation than when the cover was removed (e.g., the cover 306 may also be rotated). For example, if the disc 310 is rotated 90 degrees in the clockwise direction, the cover 306 may also require a 90-degree rotation in the clockwise direction in order for the keyed surfaces of the spindle portion 400 and the upper portion of the disc 310 align, so that the spindle portion 400 may be fully inserted into the disc 310, and therefore the cover 306 may be fully sealed against the body 304.

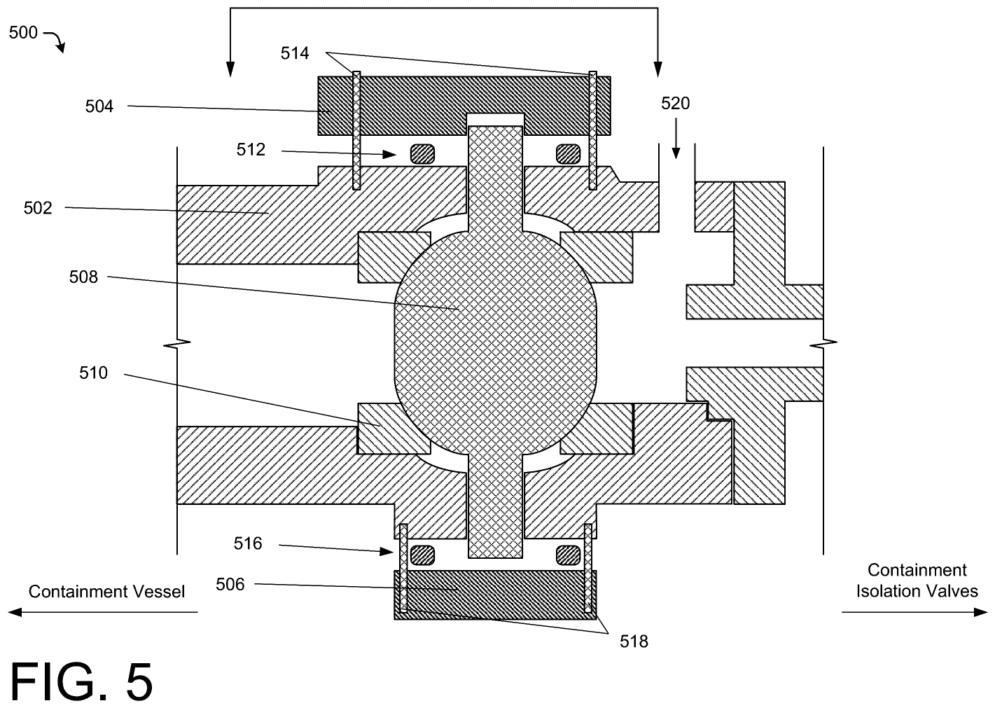

FIG. 5 illustrates a side-looking cross-sectional view of another embodiment of a CITF 500. For example, the CITF 500 may include a test port (e.g., a test port 520) and a cover (e.g., a first cover 504) with a local position indication.

In an embodiment, the CITF 500 may include a body 502, the first cover 504, a second cover 506, a disc 508, and a seat 510. The first cover 504 may include a seal 512 and dual keys 514. The second cover 506 may include a seal 516 and dual keys 518. The body 502 may include the test port 520. In various examples, the CITF 500 may be utilized to implement the CITF 206, as discussed above with reference to FIGS. 2 and 3. Whereas the CITF 206 is illustrated from a perspective (e.g., a side view), the CITF 500 is illustrated from another perspective (e.g., another side view).

In various examples, the first cover 504 may be moved toward the body 502. The first cover 504 may be placed against the body 502 to form a seal between the first cover 504 and the body 502. The seal between the first cover 504 and the body 502 may be firm and fluid tight. The first cover 504 may be moved toward, and placed against, a side (e.g., an upper side) of the body 502.

In those or other examples, the second cover 506 may be moved toward the body 502. The second cover 506 may be placed against the body 502 to form a seal between the second cover 506 and the body 502. The seal between the second cover 506 and the body 502 may be firm and fluid tight. The second cover 506 may be moved toward, and placed against, a side (e.g., a lower side) of the body 502.

In various examples, securing the first cover 504 to the body 502 includes threaded fasteners, studs and nuts, or any other reasonable faster. In those or other examples, the second cover 406 maybe secured to the body 502 in a similar way as, or a different way from, the first cover 504 being secured to the body 502.

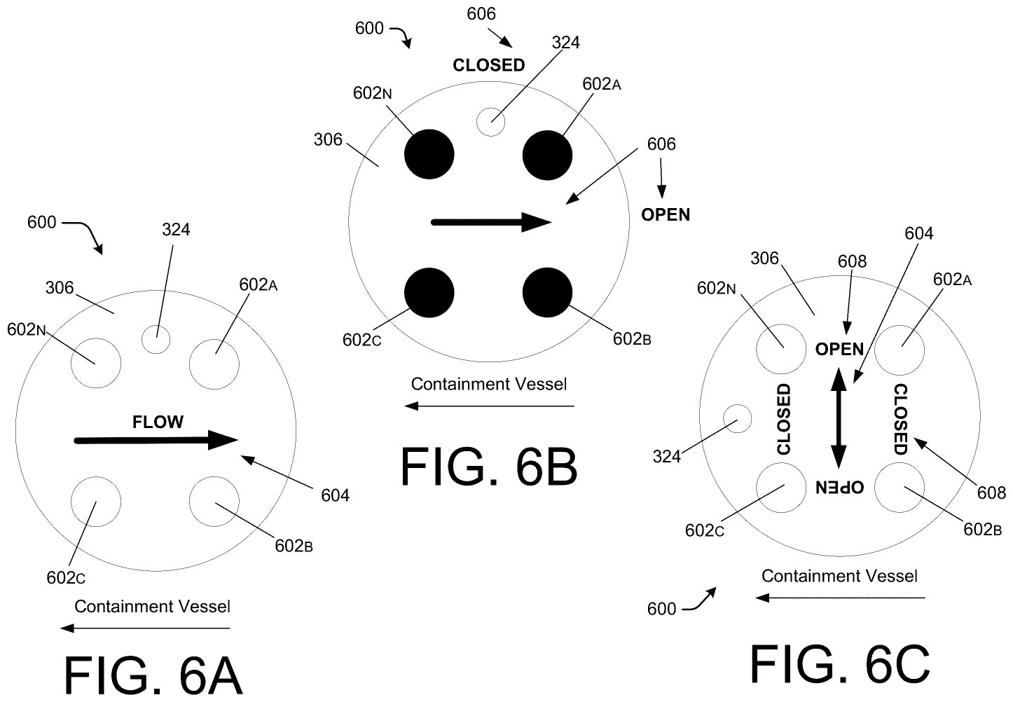

FIGS. 6A-6C illustrate example top views of a CITF cover 600 for a CITF 206 integrated with visual indication of CITF 206 position and/or flow path direction through the CITF 206. For example, the CITF 206 may include a cover (e.g., the first cover 504 and/or the second cover 506, as discussed above with reference to FIG. 5) and a test port (e.g., the test port 520, as discussed above with reference to FIG. 5). Individual ones of the first cover 504 and/or the second cover 506 may have an indicator for whether the port is open or closed. The test port may be located adjacent to the containment isolation valve.

In embodiments, the CITF cover 600 may include one or more apertures 602. In embodiments, the CITF cover 600 may include a flow indicator 604. It is understood that the flow indicator 604 may include a visual representation of direction (e.g., an arrow) and/or verbal representation (e.g., flow, etc.).

In some embodiments, the apertures 602 may be sized and configured to receive fasteners used to couple the CITF cover 600 to a CITF 206. In some embodiments, the apertures may be sized to receive one or more protrusions extending from a CITF body (not shown), which may be useful during installation and/or removal of the CITF cover 600 (e.g., ensuring alignment between a CITF cover and the CITF in low-visibility conditions, providing support for the CITF cover 600 when fasteners are installed and/or removed, etc.). While the apertures 602 are depicted within FIGS. 6A-6C as being uniform in size, in embodiments, the size of each aperture 602 may be sized according to its purpose. For example, an aperture configured to receive a fastener may be sized appropriately for the fastener while an aperture configured to receive an alignment pin may be sized and shaped appropriately for the alignment pin.

It is understood that CITF cover 600 may include any suitable number of apertures 602 as desired (i.e., a CITF cover 600 with a large diameter may include more apertures than a CITF cover 600 with a small diameter). It is also understood that the size of each aperture 602(a-n) may vary.

FIG. 6A illustrates a top view of an embodiment of a CITF cover 600 utilizing a flow indicator 604. Although FIG. 6A depicts the verbal representation as “flow” in English, it is understood that the verbal representation may be any word in any language, as required. In an embodiment, the CITF cover 600 may be positioned such that the flow indicator 604 may be parallel to the flow path of fluid through the disc 310 of the CITF 206, in order to provide visual indication of the current orientation of the disc 310. For example, prior to the CITF cover 600 being removed, the flow indicator 604 may show flow being directed parallel to the flow path through the CITF 206. The CITF cover 600 may be removed and the disc 310 may be rotated 90 degrees. The CITF cover 600 may be rotated 90 degrees and reinstalled on the CITF 206. The flow indicator 604 provides instant visual indication of the position of the disc 310 without requiring the removal of the CITF cover 600.

FIG. 6B illustrates a top view of an embodiment of a CITF cover 600 utilizing a position indicator 606. In an embodiment, the position indicator 606 may include external components (i.e., a portion of the valve position indicator is external to the CITF cover 600). For example, in an embodiment, the cover may include a visible arrow and positions at various location adjacent to the CITF cover 600. In the example, the CITF cover 600 may be oriented such that the arrow on the CITF cover 600 points to a valve position located adjacent to the CITF cover 600. In an embodiment, the CITF cover 600 may be positioned such that the flow indicator 604 may be parallel to the flow path of fluid through the disc 310 of the CITF 206, in order to provide visual indication of the current orientation of the disc 310. For example, prior to the CITF cover 600 being removed, the flow indicator 604 may show flow being directed parallel to the flow path through the CITF 206. The CITF cover 600 may be removed and the disc 310 may be rotated 90 degrees. The CITF cover 600 may be rotated 90 degrees and reinstalled on the CITF 206. The flow indicator 604 provides instant visual indication of the position of the disc 310 without requiring the removal of the CITF cover 600.

FIG. 6C illustrates a top view of an embodiment of a CITF cover 600 utilizing a flow indicator 604 and a position indicator 608. In an embodiment, the CITF cover 600 may be positioned such that the flow indicator 604 may be parallel to the flow path of fluid through the disc 310 of the CITF 206, in order to provide visual indication of the current orientation of the disc 310. In an embodiment, the position indicator 608 may include verbal indication of the orientation of the disc 310 of the CITF 206. In embodiments, the position indicator may include several words wherein only one of the words is properly oriented for reading. For example, when the CITF cover 600 is oriented to allow flow through the CITF 206, the OPEN indication may be right-side-up while other words may be upside-down and/or sideways.

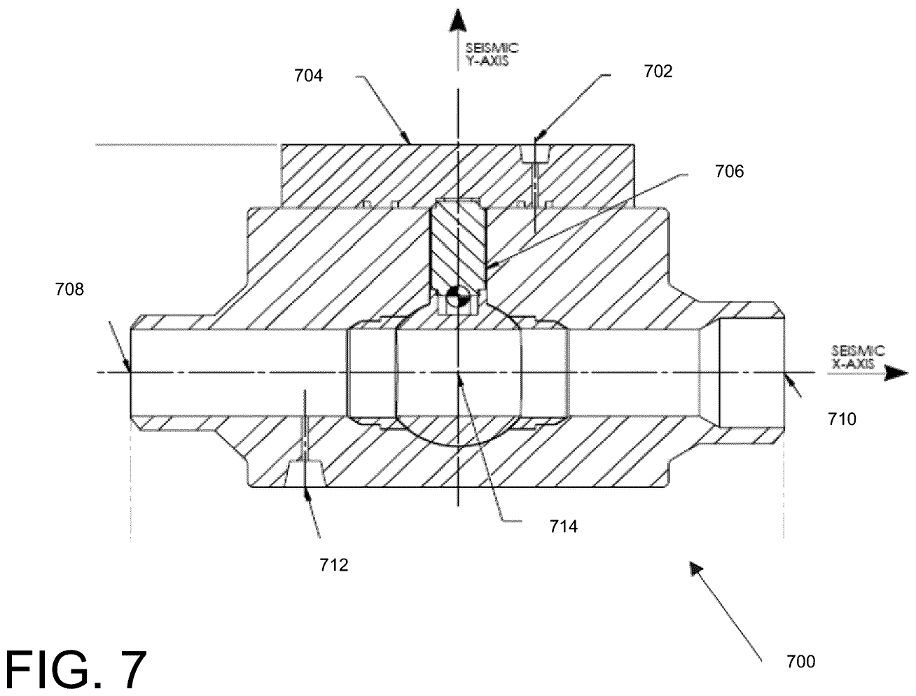

FIG. 7 shows cross sectional views of the containment isolation test fixture 700. 708 shows the top side of the containment isolation valve and 710 shows the bottom side of the containment vessel. A cover 704 is bolted or locked and keyed with the position of the ball and includes local position indication on the top of the cover. The cover 704 includes a double cover 702 with a test port and plug. The stem 706 is centrally located and does not protrude beyond the cover 704. The test plug 712 is disposed opposite of the cover 704. Unidirectional seal 714 is provided between the containment isolation valve and the containment vessel.

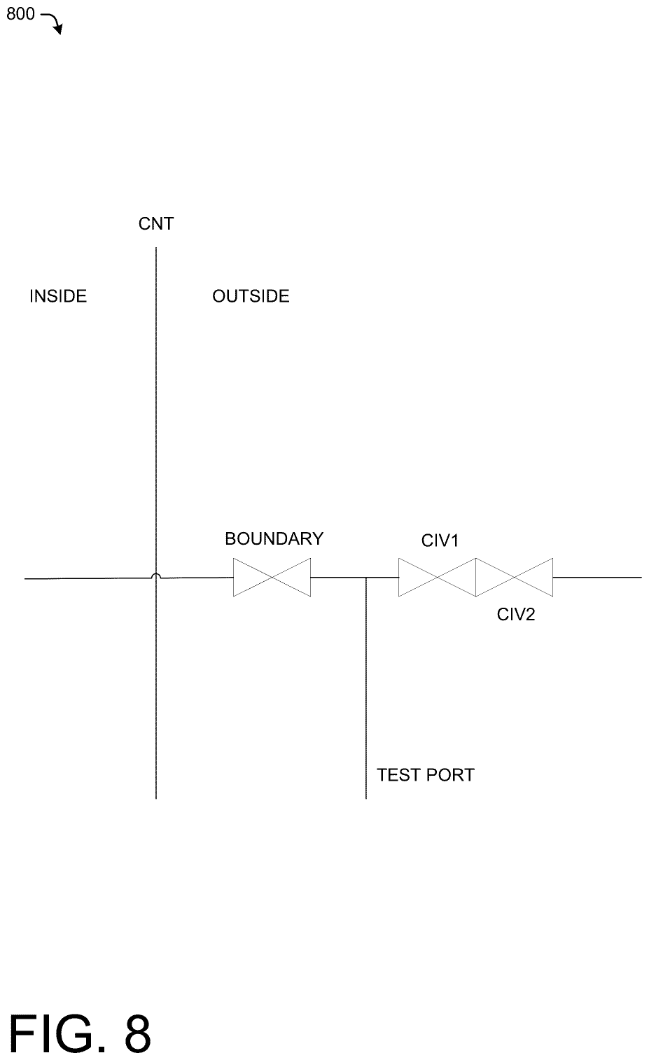

FIG. 8 shows a diagram of a piping and instrumentation diagram (“P&ID”) showing the need for an isolation barrier to allow for an in-situ leak rate pressure test between the containment vessel (“CNV”) and CIV. The boundary and the two containment isolation valves are located on the outside of the containment vessel. The test port is located between the boundary and the two containment isolation valves.

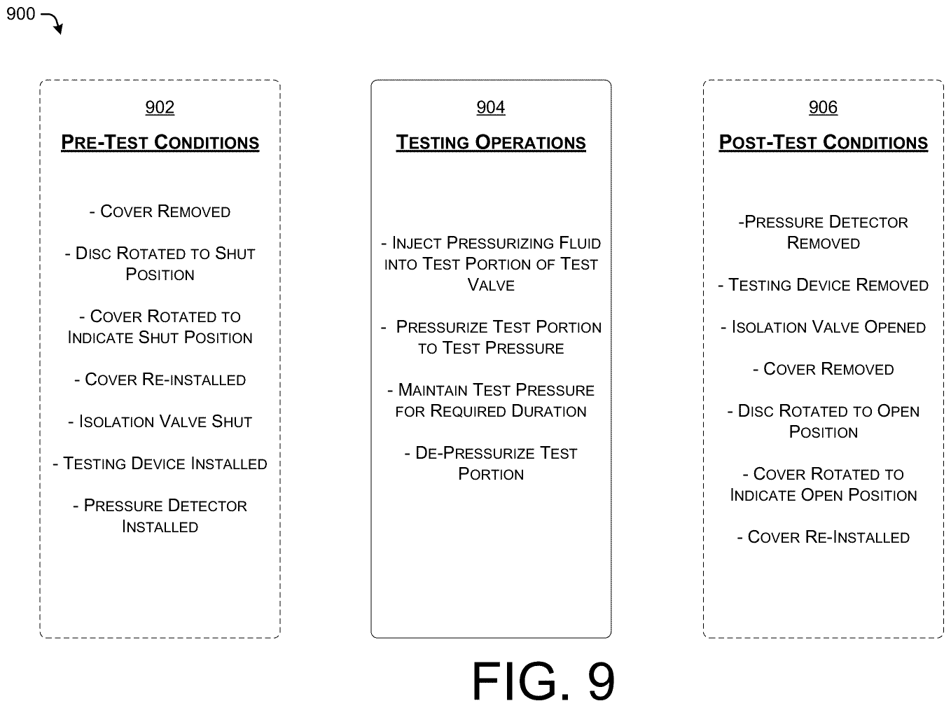

FIG. 9 illustrates a block diagram 900 with various conditions related to a process for performing testing operations. The order in which operations of the process or steps are described is not intended to be construed as a limitation, and any number of the described operations and/or conditions may be combined in any order and/or in parallel to operate a CITF 206 (e.g., the CITF 206, as discussed above with reference to FIGS. 2, 3, and 4) to perform testing operations.

Various pre-test conditions 902 may be utilized to perform, and/or be performed as part of, the process for performing testing operations. The pre-test conditions 902 may include the cover 306 being removed, the disc 310 being rotated such that the disc 310 is oriented to block fluid flow through the body 304. The pre-test conditions may include the cover 306 being rotated such that the flow indicator 604 and/or the position indicator (606/608) being oriented to indicate that the test valve is shut. The pre-test conditions may include the cover 306 being re-installed to the body 304. The pre-test conditions may include the CIV 208 (e.g., the CIV being tested) being shut, the pressure monitoring system being attached to port 322, and the leak testing system being attached to port 326.

The process may include various testing operations 904. For example, the process may include injecting, via the leak testing system through port 326, pressurizing fluid into the isolated portion of the CITF 206, pressurizing the isolated portion of the CITF 206 utilizing the pressurizing fluid. The process may include maintaining the test pressure for a specified test duration, and once the specified test duration has been reached, de-pressurizing the isolated portion of the CITF 206.

Various post-test conditions 906 may be utilized based on performing, and/or be performed as part of, the process for performing testing operations. The post-test conditions 906 may include the pressure monitoring system (e.g., attached to port 322) being removed. The post-test conditions 906 may include the leak testing system (e.g., attached to port 326) being removed. The post-test conditions 906 may include the CIV 208 (e.g., the CIV being tested) being opened. The post-test conditions 906 may include the cover 306 being removed. The post-test conditions 906 may include the disc 310 being rotated such that the disc 310 is oriented to allow fluid flow through the body 304. The post-test conditions 906 may include the cover 306 being rotated such that the flow indicator 604 and/or the position indicator (606/608) is oriented to indicate that the test valve is open. The post-test conditions 906 may include the cover 306 being re-installed.

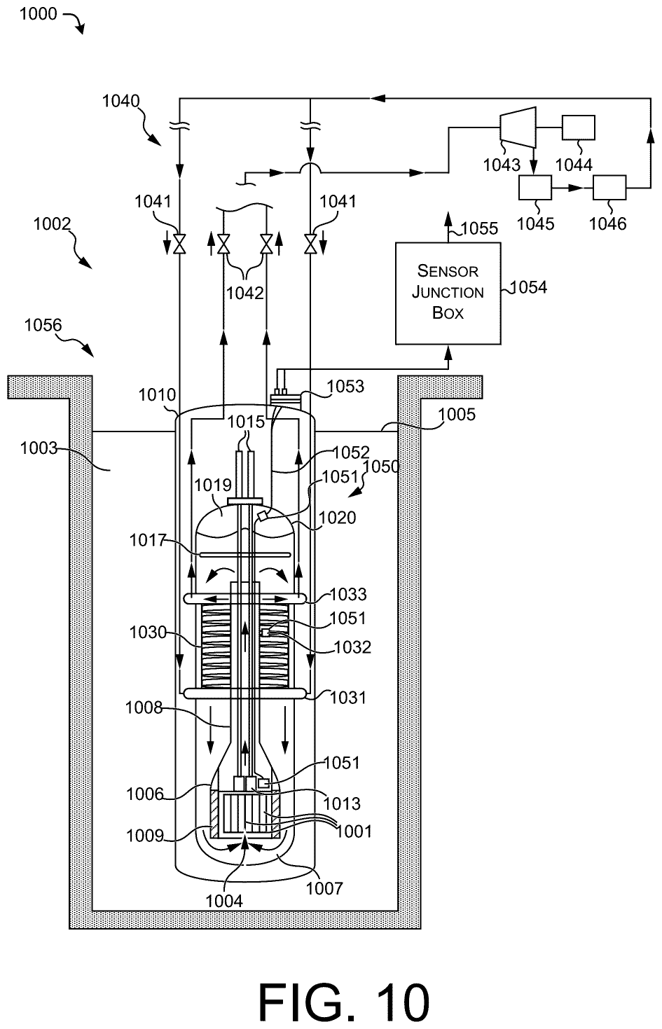

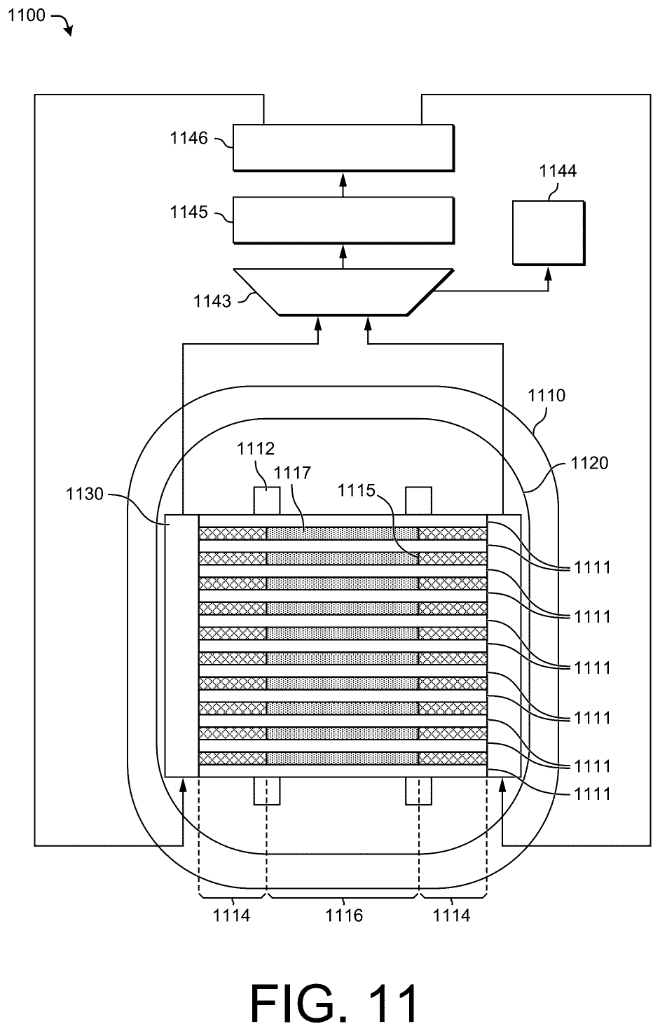

FIGS. 10 and 11 illustrate representative nuclear reactors that may be included in embodiments of the present technology. FIG. 10 shows a schematic diagram of an exemplary nuclear reactor module for coupling with a pressure swing adsorption system. In one embodiment, the nuclear reactor module may be a light pressurized water reactor (PWR) but may be different types of reactors utilizing a variety of fuels and located on terrestrial, maritime, and extraterrestrial sites. FIG. 10 shows a representative nuclear reactor that may be included in embodiments of the present technology. FIG. 10 is a partially schematic, partially cross-sectional view of a nuclear reactor system 1000 configured in accordance with embodiments of the present technology. The system 1000 can include a power module 1002 having a reactor core 1004 in which a controlled nuclear reaction takes place. Accordingly, the reactor core 1004 can include one or more fuel assemblies 1001. The fuel assemblies 1001 can include fissile and/or other suitable materials. Heat from the reaction generates steam at a steam generator 1030, which directs the steam to a power conversion system 1040. The power conversion system 1040 generates electrical power, and/or provides other useful outputs, such as super-heated steam. A sensor system 1050 is used to monitor the operation of the power module 1002 and/or other system components. The data obtained from the sensor system 1050 can be used in real time to control the power module 1002, and/or can be used to update the design of the power module 1002 and/or other system components.

The power module 1002 includes a containment vessel 1010 (e.g., a radiation shield vessel, or a radiation shield container) that houses/encloses a reactor vessel 1020 (e.g., a reactor pressure vessel, or a reactor pressure container), which in tum houses the reactor core 1004. The containment vessel 1010 can be housed in a power module bay 1056. The power module bay 1056 can contain a cooling pool 1003 filled with water and/or another suitable cooling liquid. The bulk of the power module 1002 can be positioned below a surface 1005 of the cooling pool 1003. Accordingly, the cooling pool 1003 can operate as a thermal sink, for example, in the event of a system malfunction.

A volume between the reactor vessel 1020 and the containment vessel 1010 can be partially or completely evacuated to reduce heat transfer from the reactor vessel 1020 to the surrounding environment (e.g., to the cooling pool 1003). However, in other embodiments the volume between the reactor vessel 1020 and the containment vessel 1010 can be at least partially filled with a gas and/or a liquid that increases heat transfer between the reactor vessel 1020 and the containment vessel 1010. For example, the volume between the reactor vessel 1020 and the containment vessel 1010 can be at least partially filled (e.g., flooded with the primary coolant 1007) during an emergency operation.

Within the reactor vessel 1020, a primary coolant 1007 conveys heat from the reactor core 1004 to the steam generator 1030. For example, as illustrated by arrows located within the reactor vessel 1020, the primary coolant 1007 is heated at the reactor core 1004 toward the bottom of the reactor vessel 1020. The heated primary coolant 1007 (e.g., water with or without additives) rises from the reactor core 1004 through a core shroud 1006 and to a riser tube 1008. The hot, buoyant primary coolant 1007 continues to rise through the riser tube 1008, then exits the riser tube 1008 and passes downwardly through the steam generator 1030. The steam generator 1030 includes a multitude of conduits 1032 that are arranged circumferentially around the riser tube 1008, for example, in a helical pattern, as is shown schematically in FIG. 10. The descending primary coolant 1007 transfers heat to a secondary coolant (e.g., water) within the conduits 1032, and descends to the bottom of the reactor vessel 1020 where the cycle begins again. The cycle can be driven by the changes in the buoyancy of the primary coolant 1007, thus reducing or eliminating the need for pumps to move the primary coolant 1007.

The steam generator 1030 can include a feedwater header 1031 at which the incoming secondary coolant enters the steam generator conduits 1032. The secondary coolant rises through the conduits 1032, converts to vapor (e.g., steam), and is collected at a steam header 1033. The steam exits the steam header 1033 and is directed to the power conversion system 1040.

The power conversion system 1040 can include one or more steam valves 1042 that regulate the passage of high pressure, high temperature steam from the steam generator 1030 to a steam turbine 1043. The steam turbine 1043 converts the thermal energy of the steam to electricity via a generator 1044. The low-pressure steam exiting the turbine 1043 is condensed at a condenser 1045, and then directed (e.g., via a pump 1046) to one or more feedwater valves 241. The feedwater valves 1041 control the rate at which the feedwater re-enters the steam generator 1030 via the feedwater header 1031. In other embodiments, the steam from the steam generator 1030 can be routed for direct use in an industrial process, such as a Hydrogen (H₂) and Oxygen (O₂) production plant, a chemical production plant, and/or the like, as described in detail below. Accordingly, steam exiting the steam generator 1030 can bypass the power conversion system 1040.

The power module 1002 includes multiple control systems and associated sensors. For example, the power module 1002 can include a hollow cylindrical reflector 1009 that directs neutrons back into the reactor core 1004 to further the nuclear reaction taking place therein. Control rods 1013 are used to modulate the nuclear reaction and are driven via fuel rod drivers 1015. The pressure within the reactor vessel 1020 can be controlled via a pressurizer plate 1017 (which can also serve to direct the primary coolant 1007 downwardly through the steam generator 1030) by controlling the pressure in a pressurizing volume 1019 positioned above the pressurizer plate 1017.

The sensor system 1050 can include one or more sensors 1051 positioned at a variety of locations within the power module 1002 and/or elsewhere, for example, to identify operating parameter values and/or changes in parameter values. The data collected by the sensor system 1050 can then be used to control the operation of the system 1000, and/or to generate design changes for the system 1000. For sensors positioned within the containment vessel 1010, a sensor link 1052 directs data from the sensors to a flange 1053 (at which the sensor link 1052 exits the containment vessel 1010) and directs data to a sensor junction box 1054. From there, the sensor data can be routed to one or more controllers and/or other data systems via a data bus 1055. The containment vessel 1010 of FIG. 10 and containment system should ensure leakage integrity is maintained for the containment.

FIG. 11 is a partially schematic, partially cross-sectional view of a nuclear reactor system 1100 configured in accordance with additional embodiments of the present technology. In some embodiments, the nuclear reactor system 1100 (“system 1100”) can include some features that are at least generally similar in structure and function, or identical in structure and function, to the corresponding features of the system 1100 described in detail above with reference to FIG. 11 and can operate in a generally similar or identical manner to the system 1100.

In the illustrated embodiment, the system 1100 includes a reactor vessel 1120 and a containment vessel 1110 surrounding/enclosing the reactor vessel 1120. In some embodiments, the reactor vessel 1120 and the containment vessel 1110 can be roughly cylinder-shaped or capsule-shaped. The system 1100 further includes a plurality of heat pipe layers 1111 within the reactor vessel 1120. In the illustrated embodiment, the heat pipe layers 1111 are spaced apart from and stacked over one another. In some embodiments, the heat pipe layers 1111 can be mounted/secured to a common frame 1112, a portion of the reactor vessel 1120 (e.g., a wall thereof), and/or other suitable structures within the reactor vessel 1120. In other embodiments, the heat pipe layers 1111 can be directly stacked on top of one another such that each of the heat pipe layers 1111 supports and/or is supported by one or more of the other ones of the heat pipe layers 1111.

In the illustrated embodiment, the system 1100 further includes a shield or reflector region 1114 at least partially surrounding a core region 1116. The heat pipe layers 1111 can be circular, rectilinear, polygonal, and/or can have other shapes, such that the core region 1116 has a corresponding three-dimensional shape (e.g., cylindrical, spherical). In some embodiments, the core region 1116 is separated from the reflector region 1114 by a core barrier 1115, such as a metal wall. The core region 1116 can include one or more fuel sources, such as fissile material, for heating the heat pipe layers 1111. The reflector region 1114 can include one or more materials configured to contain/reflect products generated by burning the fuel in the core region 1116 during operation of the system 1100. For example, the reflector region 1114 can include a liquid or solid material configured to reflect neutrons and/or other fission products radially inward toward the core region 1116. In some embodiments, the reflector region 1114 can entirely surround the core region 1116. In other embodiments, the reflector region 1114 may partially surround the core region 1116. In some embodiments, the core region 1116 can include a control material 1117, such as a moderator and/or coolant. The control material 1117 can at least partially surround the heat pipe layers 1111 in the core region 1116 and can transfer heat therebetween.

In the illustrated embodiment, the system 1100 further includes at least one heat exchanger 1130 (e.g., a steam generator) positioned around the heat pipe layers 1111. The heat pipe layers 1111 can extend from the core region 1116 and at least partially into the reflector region 1114 and are thermally coupled to the heat exchanger 1130. In some embodiments, the heat exchanger 1130 can be positioned outside of or partially within the reflector region 1114. The heat pipe layers 1111 provide a heat transfer path from the core region 1116 to the heat exchanger 1130. For example, the heat pipe layers 1111 can each include an array of heat pipes that provide a heat transfer path from the core region 1116 to the heat exchanger 1130. When the system 1100 operates, the fuel in the core region 1116 can heat and vaporize a fluid within the heat pipes in the heat pipe layers 1111, and the fluid can carry the heat to the heat exchanger 1130. The heat pipes in the heat pipe layers 1111 can then return the fluid toward the core region 1116 via wicking, gravity, and/or other means to be heated and vaporized once again.

In some embodiments, the heat exchanger 1130 can be similar to the steam generator 1030 of FIG. 10 and, for example, can include one or more helically-coiled tubes that wrap around the heat pipe layers 1111. The tubes of the heat exchanger 1130 can include or carry a working fluid (e.g., a coolant such as water or another fluid) that carries the heat from the heat pipe layers 1111 out of the reactor vessel 1120 and the containment vessel 1110 for use in generating electricity, steam, and/or the like. For example, in the illustrated embodiment the heat exchanger 1130 is operably coupled to a turbine 1143, a generator 1144, a condenser 1145, and a pump 1146. As the working fluid within the heat exchanger 1130 increases in temperature, the working fluid may begin to boil and vaporize. The vaporized working fluid (e.g., steam) may be used to drive the turbine 1143 to convert the thermal potential energy of the working fluid into electrical energy via the generator 1144. The condenser 1145 can condense the working fluid after it passes through the turbine 1143, and the pump 1146 can direct the working fluid back to the heat exchanger 1130 where it can begin another thermal cycle. In other embodiments, steam from the heat exchanger 1130 can be routed for direct use in an industrial process, such as an enhanced oil recovery operation described in detail below. Accordingly, steam exiting the heat exchanger 1130 can bypass the turbine 1143, the generator 1144, the condenser 1145, the pump 1146, etc.

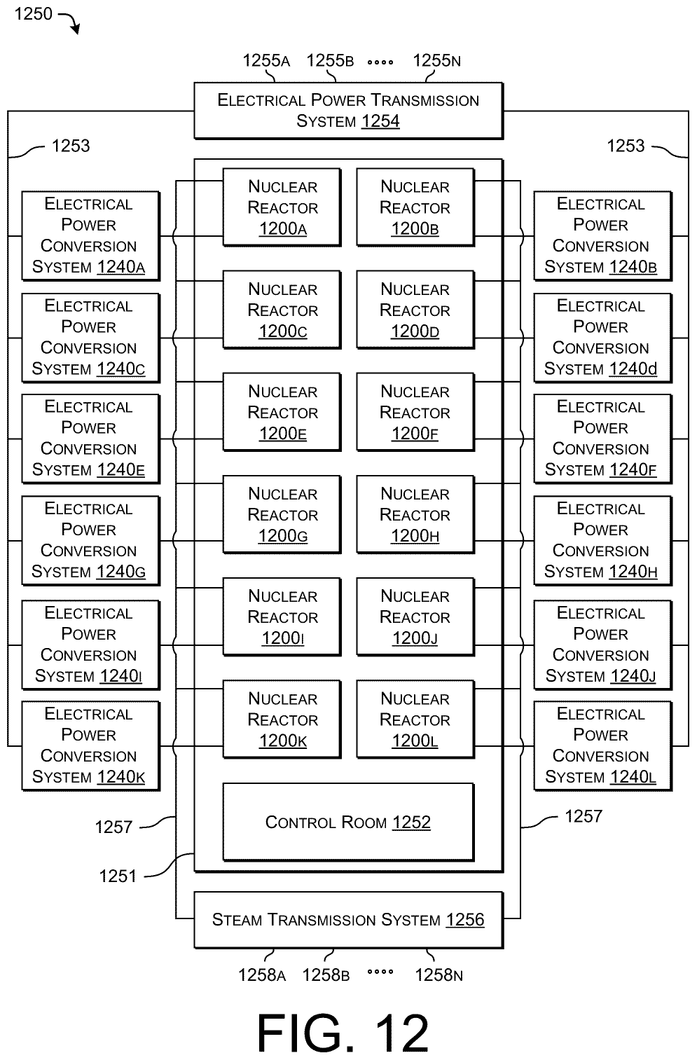

FIG. 12 is a schematic view of a nuclear power plant system 1250 including multiple nuclear reactors 1200 in accordance with embodiments of the present technology. Each of the nuclear reactors 1200 (individually identified as first through twelfth nuclear reactors 1200a-1, respectively) can be similar to or identical to the nuclear reactor 1200 and/or the nuclear reactor 1200 described in detail above with reference to FIGS. 10 and 11. The power plant system 1250 (“power plant system 1250”) can be “modular” in that each of the nuclear reactors 1200 can be operated separately to provide an output, such as electricity or steam. The power plant system 1250 can include fewer than twelve of the nuclear reactors 1200 (e.g., two, three, four, five, six, seven, eight, nine, ten, or eleven of the nuclear reactors 1200), or more than twelve of the nuclear reactors 1200. The power plant system 1250 can be a permanent installation or can be mobile (e.g., mounted on a truck, tractor, mobile platform, and/or the like). In the illustrated embodiment, each of the nuclear reactors 1200 can be positioned within a common housing 1251, such as a reactor plant building, and controlled and/or monitored via a control room 1252.

Each of the nuclear reactors 1200 can be coupled to a corresponding electrical power conversion system 1240 (individually identified as first through twelfth electrical power conversion systems 1240a-1, respectively). The electrical power conversion systems 1240 can include one or more devices that generate electrical power or some other form of usable power from steam generated by the nuclear reactors 1200. In some embodiments, multiple ones of the nuclear reactors 1200 can be coupled to the same one of the electrical power conversion systems 1240 and/or one or more of the nuclear reactors 1200 can be coupled to multiple ones of the electrical power conversion systems 1240 such that there is not a one-to-one correspondence between the nuclear reactors 1200 and the electrical power conversion systems 1240.

The electrical power conversion systems 1240 can be further coupled to an electrical power transmission system 1254 via, for example, an electrical power bus 1253. The electrical power transmission system 1254 and/or the electrical power bus 1253 can include one or more transmission lines, transformers, and/or the like for regulating the current, voltage, and/or other characteristic(s) of the electricity generated by the electrical power conversion systems 1240. The electrical power transmission system 454 can route electricity via a plurality of electrical output paths 1255 (individually identified as electrical output paths 1255a-n) to one or more end users and/or end uses, such as different electrical loads of an integrated energy system.

Each of the nuclear reactors 1200 can further be coupled to a steam transmission system 1256 via, for example, a steam bus 1257. The steam bus 1257 can route steam generated from the nuclear reactors 1200 to the steam transmission system 1256 which in tum can route the steam via a plurality of steam output paths 1258 (individually identified as steam output paths 1258a-n) to one or more end users and/or end uses, such as different steam inputs of an integrated energy system.

In some embodiments, the nuclear reactors 1200 can be individually controlled (e.g., via the control room 1252) to provide steam to the steam transmission system 1256 and/or steam to the corresponding one of the electrical power conversion systems 1240 to provide electricity to the electrical power transmission system 1254. In some embodiments, the nuclear reactors 1200 are configured to provide steam either to the steam bus 1257 or to the corresponding one of the electrical power conversion systems 1240 and can be rapidly and efficiently switched between providing steam to either. Accordingly, in some aspects of the present technology the nuclear reactors 1200 can be modularly and flexibly controlled such that the power plant system 1250 can provide differing levels/amounts of electricity via the electrical power transmission system 1254 and/or steam via the steam transmission system 1256. For example, where the power plant system 1250 is used to provide electricity and steam to one or more industrial process-such as various components of the integrated energy systems, the nuclear reactors 1200 can be controlled to meet the differing electricity and steam requirements of the industrial processes.

As one example, during a first operational state of an integrated energy system employing the power plant system 1250, a first subset of the nuclear reactors 1200 (e.g., the first through sixth nuclear reactors 1200a-f) can be configured to provide steam to the steam transmission system 1256 for use in the first operational state of the integrated energy system, while a second subset of the nuclear reactors 1200 (e.g., the seventh through twelfth nuclear reactors 1200g-1) can be configured to provide steam to the corresponding ones of the electrical power conversion systems 1240 (e.g., the seventh through twelfth electrical power conversion systems 1240g-1) to generate electricity for the first operational state of the integrated energy system. Then, during a second operational state of the integrated energy system when a different (e.g., greater or lesser) amount of steam and/or electricity is required, some or all the first subset of the nuclear reactors 1200 can be switched to provide steam to the corresponding ones of the electrical power conversion systems 1240 (e.g., the seventh through twelfth electrical power conversion systems 1240g-1) and/or some or all of the second subset of the nuclear reactors 1200 can be switched to provide steam to the steam transmission system 1256 to vary the amount of steam and electricity produced to match the requirements/demands of the second operational state. Other variations of steam and electricity generation are possible based on the needs of the integrated energy system. That is, the nuclear reactors 1200 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time consuming to switch between steam generation and electricity generation in prototypical large nuclear power plant systems.

The nuclear reactors 1200 can be individually controlled via one or more operators and/or via a computer system. Accordingly, many embodiments of the technology described herein may take the form of computer-or machine-or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter. The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A containment isolation system, comprising:
a containment vessel,
a first containment isolation valve downstream of the containment vessel;
a second containment isolation valve downstream of the first containment isolation valve; and
a test valve upstream of the first containment isolation valve and downstream of the containment vessel, the test valve including:
a body,
a disc disposed within the body, the disc configured to receive a key and to be rotated by the key before and after performing test operations utilizing at least one of the first containment isolation valve or the second containment isolation valve, the disc being configured to be rotated along with the key, and
a cover coupled to the body, the cover configured to be removed prior to insertion of the key, to enable the key to be inserted into the disc and rotated.

2. The containment isolation system of claim 1, wherein the cover includes at least one of a position indicator or a flow indicator.

3. The containment isolation system of claim 1, wherein the cover includes a test port configured to provide a fluid flow path through the cover.

4. The containment isolation system of claim 1, wherein the body includes a test port configured to provide a fluid flow path through the body.

5. The containment isolation system of claim 1, wherein the test valve further includes a spindle having a first end configured to engage with the cover and a second end opposite the first end configured to engage with a disc.

6. The containment isolation system of claim 1, wherein the cover includes a spindle configured to extend into the body.

7. The containment isolation system of claim 1, wherein the cover includes a spindle configured to engage with the disc.

8. An integrated system, comprising:
a nuclear reactor; and
a containment isolation system including;
a containment isolation test valve, including:
a test port configured to receive a pressurizing fluid, and
a test port plug configured to be rotated to seal the test port; and
a containment isolation valve downstream of the containment isolation test valve configured to restrict fluid flow through a disc and seat assembly disposed within the containment isolation valve.

9. The integrated system of claim 8, wherein:
the containment isolation test valve is a first containment isolation test valve, and
the integrated system further comprising a second containment isolation test valve.

10. The integrated system of claim 8, wherein the containment isolation test valve includes a cover, the cover having at least one of a position indicator or a flow indicator.

11. The integrated system of claim 8, wherein:
the test port is a first test port,
the test port plug is a first test port plug, and
the containment isolation valve further including a cover, the cover including:
a second test port configured to provide a fluid flow path through the cover, and
a second test port plug configured to be rotated to seal the second test port.

12. The integrated system of claim 8, wherein the containment isolation test valve further includes a spindle having a first end configured to engage with a cover and a second end opposite the first end configured to engage with a disc.

13. The integrated system of claim 8, wherein the containment isolation valve includes a cover having a spindle, the spindle configured to extend into a body of the containment isolation valve.

14. The integrated system of claim 8, wherein the containment isolation valve includes a cover having a spindle configured to engage with a disc, the disc disposed within a body of the containment isolation test valve.

15. An isolation test valve, including:
a body, having a first test port configured to receive a pressurizing fluid,
a first test port plug configured to be rotated to seal the first test port,
a disc disposed within the body, the disc configured to receive an operating tool and to be rotated by the operating tool before and after performing isolation test operations, the disc being configured to be rotated along with the operating tool,
a cover configured to be coupled to the body, the cover including a second test port configured to receive the pressurizing fluid, and a second test port plug configured to be rotated to seal the second test port,
a first seal disposed between the cover and the body, the first seal disposed adjacent to a first side of the second test port, and
a second seal disposed between the cover and the body, the second seal disposed adjacent to a second side of the second test port, the second side of the second test port being opposite the first side of the second test port.

16. The isolation test valve of claim 15, wherein the cover includes at least one of a position indicator or a flow indicator.

17. The isolation test valve of claim 15, wherein the cover includes a spindle configured to extend into the body of the isolation test valve.

18. The isolation test valve of claim 15, wherein the cover includes a spindle configured to engage with the disc.

19. The isolation test valve of claim 15, wherein the isolation test valve further includes a spindle having a first end configured to engage with the cover and a second end opposite the first end configured to engage with the disc.

20. The isolation test valve of claim 15, wherein the first test port is on a first side of the disc, and the second test port is on a second side of the disc, the second side being opposite the first side.
